(19) United States
(12) Patent Application Publication
(10) Pub. No.: US 2006/0139825 A1
(43) Pub. Date: Jun. 29, 2006

(54) Protective circuit for protecting chip from misoperation

(75) Inventor: Heng-Chen Kuo, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/300,723

(22) Filed: Dec. 15, 2005

(30) Foreign Application Priority Data
Dec. 23, 2004 (CN) 200410091875.3

(51) Int. Cl. H02H 9/00

(52) U.S. Cl. 361/56

(57) ABSTRACT

A protective circuit for a chip includes an input terminal for receiving a power supply voltage, an output terminal for outputting a driving voltage to the chip, a first BJT and a second BJT. A base of the first BJT is connected to the input terminal and an emitter of the first BJT is grounded. A collector of the first BJT is coupled to the input terminal via a first terminal. A base of the second BJT is connected to a collector of the first BJT and an emitter of the second BJT is coupled to the input terminal via a second resistor and is connected to the output terminal. A collector of the second BJT is grounded.

### CROSS-REFERENCE TO RELATED APPLICATION

Related subject matter is disclosed in a co-pending U.S. patent application entitled “PROTECTIVE CIRCUIT FOR PROTECTING CHIP FROM MISOPERATION,” which is assigned to the same assignee as that of the present application.

### BACKGROUND

1. Field of the Invention

The present invention relates to a protective circuit for a chip, and more particularly to a protective circuit for preventing a chip from misoperation.

2. General Background

In general, in a power supply circuit for a chip, a filter capacitor is connected to a power supply in order to stabilize waveform of an input voltage for the chip. However, when the power supply is turned on or turned off instantly, the waveform of the input voltage is slowly changed because of the filter capacitor. Thus, the chip will be in an unstable state between a work state and a close state. The chip in an unstable state will carry out a misoperation.

A common method to prevent the chip from misoperation is to use a Reset IC (Integrated Circuit) in a power supply circuit, such as DS1233Z, LMS33460, TL7705A, TL7757A and etc. The Reset IC has a voltage reset and test functions. However, a circuit structure of such a Reset IC is complex. In addition, a voltage that the IC can test is non-adjustable. So the power supply circuit should use different Reset ICs to prevent different chips from misoperation.

What is needed is a protective circuit for preventing a chip from misoperation which has a simple structure and low cost.

### SUMMARY

A protective circuit for a chip includes an input terminal for receiving a power supply voltage, an output terminal for outputting a driving voltage to the chip, a first BJT and a second BJT. A base of the first BJT is connected to the input terminal and an emitter of the first BJT is grounded. A collector of the first BJT is coupled to the input terminal via a first terminal. A base of the second BJT is connected to a collector of the first BJT and an emitter of the second BJT is coupled to the input terminal via a second resistor and is connected to the output terminal. A collector of the second BJT is grounded.

When the power supply voltage is more than a least working voltage of the chip, the first BJT is turned on and outputs a low level voltage to the second BJT. Then the second BJT is turned on and a low level voltage is inputted to the chip. Thus, the chip is at a work mode. When the power supply voltage is less than the least working voltage of the chip, the first BJT is turned off and outputs a high level voltage to the second BJT. Then the second BJT is turned off and a high level voltage is inputted to the chip. Thus, the chip is closed. Therefore the protective circuit can prevent the chip from misoperation when the power supply voltage is less than the least working voltage of the chip.

Other advantages and novel features will become more apparent from the following detailed description when taken in conjunction with the accompanying drawings, in which:

### BRIEF DESCRIPTION OF THE DRAWINGS

FIG. 1 is a schematic diagram of a protective circuit in accordance with a preferred embodiment of the present invention, together with one chip;

FIG. 2 is the schematic diagram of the protective circuit of FIG. 1, together with two chips; and

FIG. 3 is a circuit diagram of a voltage detecting circuit and a voltage switching circuit of the FIG. 1 and FIG. 2.

### DETAILED DESCRIPTION OF THE EMBODIMENTS

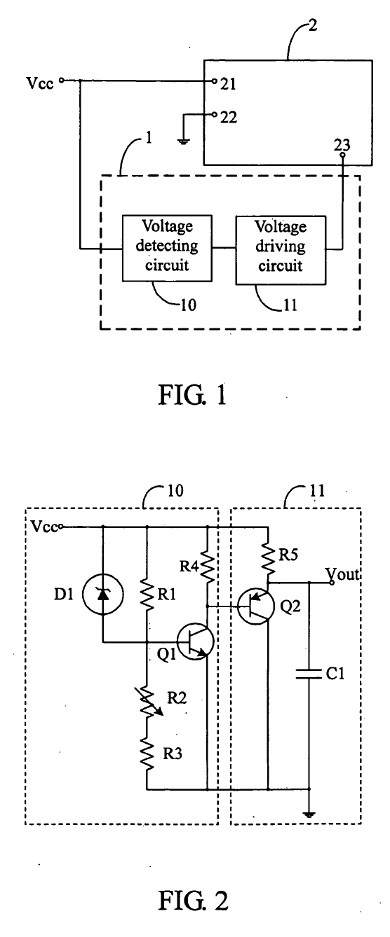

Referring to FIG. 1, a protective circuit 1 in accordance with a preferred embodiment of the present invention is applied to prevent an electronic component like a chip 2 from misoperation. The protective circuit 1 includes a voltage detecting circuit 10 and a voltage driving circuit 11. A pin 21 of the chip 2 is coupled to a power source (Vcc) terminal, and a pin 22 of the chip 2 is grounded. A power supply voltage is inputted to the protective circuit 1 via the Vcc terminal. An output terminal of the voltage detecting circuit 10 is connected to an input terminal of the voltage driving circuit 11. An output terminal of the voltage driving circuit 11 is connected to an enable pin 23 of the chip 2.

The voltage detecting circuit 10 detects a value of the power supply voltage and outputs a control signal to the voltage driving circuit 11, according to the value of the power supply voltage. The control signal from the voltage detecting circuit 10 controls the voltage driving circuit 11 to be turned on or turned off, thereby outputting a low level voltage or a high level voltage to the enable pin 23 of the chip 2, therefore controlling the chip 2 to work or close.

The chip 2 may have an enable pin or a shutdown pin. If the protective circuit 1 is connected to the enable pin, the chip 2 works when the enable pin receives a low level voltage. If the protective circuit 1 is connected to the shutdown pin, the chip 2 works when the shutdown pin receives a high level voltage. In the preferred embodiment of the present invention, the chip 2 has the enable pin 23.

Referring to FIG. 2, the voltage detecting circuit 10 includes a Bipolar Junction Transistor (BJT) Q1 and a Zener Diode D1. The BJT Q1 is a NPN transistor. The Vcc terminal is grounded via a resistor R1, an adjustable resistor R2 and a resistor R3 in turn. A base of the BJT Q1 is connected to a node between the resistor R1 and the resistor R2. A Zener Diode D1 is connected between the Vcc terminal and the node, and in parallel with the resistor R1. The Zener Diode D1 is used to stabilize the power supply voltage. An emitter of the BJT Q1 and the resistor R3 are grounded. A collector of the BJT Q1 is coupled to the Vcc terminal via a resistor R4. The voltage driving circuit 11 includes a BJT Q2. The BJT Q2 is a PNP transistor. A base of the BJT Q2 is connected to the collector of the BJT Q1. An emitter of the BJT Q2 is connected to the Vcc terminal via a resistor R5 and is connected to a Vout terminal. A collector of the BJT Q2 is grounded. A capacitor C1 is connected to the emitter of the BJT Q2 to filter an output voltage of the BJT Q2.

Presuming that a turn-over voltage of the BJT Q1 is VQ1, a turn-over voltage of the BJT Q2 is VQ2, the least working voltage of the chip 2 is Vchip2, a voltage of the base of the BJT Q1 is Vb, and the power supply voltage is Vcc. If Vcc≧VQ2+Vchip2, a partial voltage of the resistor R2 and the resistor R3 is more than the turn-over voltage of the BJT Q1, thereby the BJT Q1 is turned on and works in a saturation region. Therefore an output voltage of the collector of the BJT Q1 is at a low level, that is, an input voltage of the base of the BJT Q2 is at a low level. Because the BJT Q2 is a PNP transistor, the BJT Q2 is turned on. Therefore the Vout terminal outputs a low level voltage to the enable pin 23 of the chip 2. Thus, the chip 2 is at a work mode. If Vcc≦VQ2+Vchip2, the partial voltage of the resistor R2 and the resistor R3 is less than the turn-over voltage of the BJT Q1, thereby the BJT Q1 is turned off. Therefore an output voltage of the collector of the BJT Q1 is at a high level and the BJT Q2 is turned off. Therefore the Vout terminal outputs a high level voltage to the enable pin 23 of the chip 2. Thus, the chip 2 is closed.

Values of the resistors R1, R2, R3 can be selected according a relationship of the Vchip, the VQ2 and the Vb, that is:

$$\frac{Vchip 2 + VQ 2}{Vb} = \frac{R 1 + R 2 + R 3}{R 2 + R 3}$$

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A protective circuit for protecting a chip from misoperation, the chip comprising a first end receiving a power supply voltage and a second end, the protective circuit comprising:
an input terminal for receiving the power supply voltage;
an output terminal for outputting a driving signal to the second end of the chip;
a first Bipolar Junction Transistor (BJT) comprising a base connected to the input terminal, an emitter being grounded, and a collector coupled to the input terminal via a first resistor; and
a second BJT comprising a base connected to the collector of the first BJT, an emitter coupled to the input terminal via a second resistor and connected to the output terminal, and a collector being grounded.

2. The protective circuit as claimed in claim 1, wherein a polarity of the first BJT is contrary to a polarity of the second BJT.

3. The protective circuit as claimed in claim 1, wherein the voltage detecting circuit further comprises a Zener Diode for stabilizing the power supply voltage, and the Zener Diode is connected between the input terminal and the base of the first BJT.

4. The protective circuit as claimed in claim 1, wherein the voltage switching circuit further comprises a capacitor for filtering an output voltage of the second BJT, and the capacitor is connected between the emitter of the second BJT and a ground.

5. The protective circuit as claimed in claim 1, wherein a third resistor and a forth resistor are connected in series between the input terminal and ground, and the base of the first BJT is connected to a node between the third resistor and the forth resistor.

6. A protective circuit for protecting a chip from misoperation, the chip comprising a first end receiving a power supply voltage and a second end, the protective circuit comprising:
a voltage detecting circuit for detecting a value of a power supply voltage, the voltage detecting circuit comprising an input terminal receiving the power supply voltage and an output terminal outputting a control signal; and
a voltage driving circuit to turn on or turn off the chip by outputting a driving signal to the second end of the chip according to the control signal from the voltage detecting circuit, the voltage switching circuit comprising an input terminal receiving the control signal and an output terminal connected to the second end of the chip.

7. The protective circuit as claimed in claim 6, wherein the voltage detecting circuit comprises a first Bipolar Junction Transistor (BJT), a base of the first BJT receives the power supply voltage, an emitter of the first BJT is grounded, a collector of the first BJT receives the power supply voltage via a first resistor.

8. The protective circuit as claimed in claim 7, wherein the voltage switching circuit comprises a second BJT, a base of the second BJT is connected to the collector of the first BJT, an emitter of the second BJT receives the power supply voltage via a second resistor and connected to the output terminal of the voltage driving circuit, and a collector of the second BJT is grounded.

9. The protective circuit as claimed in claim 8, wherein a polarity of the first BJT is contrary to a polarity of the second BJT.

10. The protective circuit as claimed in claim 6, wherein the voltage detecting circuit further comprises a Zener Diode for stabilizing the power supply voltage.

11. The protective circuit as claimed in claim 6, wherein the voltage switching circuit further comprises a capacitor for filtering an output voltage of the second BJT.

12. A circuit for ensuring normal operation of an electronic component, comprising:
a voltage detecting circuit electrically connectable to a power source electrically connectable with an electronic component, said voltage detecting circuit capable of detecting a current status of said power source and providing a control signal based on said current status, said voltage detecting circuit being adjustable according to at least one requirement of said electronic component in order to perform said detecting; and
a voltage driving circuit electrically connectable between said voltage detecting circuit and said electronic component, said voltage driving circuit capable of accepting said control signal from said voltage detecting circuit, and controlling said electronic component to be in a selective one of an active state thereof and an inactive state thereof according to said control signal.

13. The circuit as claimed in claim 12, wherein said voltage detecting circuit provides said control signal to control said electronic component being in said inactive state thereof when said current status of said power source indicates that a voltage of said power source is lower than a threshold voltage preset in said circuit.

14. The circuit as claimed in claim 12, wherein said voltage detecting circuit is adjustable by means of changing a presenting value of an adjustable resistor installed therein.
